(19) United States
(12) Patent Application Publication
(10) Pub. No.: US 2023/0325465 A1
(43) Pub. Date: Oct. 12, 2023

(54) COMPUTER-READABLE RECORDING MEDIUM STORING INFORMATION PROCESSING PROGRAM AND INFORMATION PROCESSING METHOD

(71) Applicant: Fujitsu Limited, Kawasaki-shi (JP)

(72) Inventor: Eiji OHTA, Yokohama (JP)

(73) Assignee: Fujitsu Limited, Kawasaki-shi (JP)

(21) Appl. No.: 18/150,349

(22) Filed: Jan. 5, 2023

(30) Foreign Application Priority Data
Mar. 23, 2022 (JP) 2022-047641

(51) Int. Cl. G06F 7/523; G06F 17/16

(52) U.S. Cl. CPC G06F 17/16; G06F 7/523

(57) ABSTRACT

A non-transitory computer-readable recording medium stores an information processing program for causing a computer to execute a process including: receiving a setting of a parallel calculation condition that is a condition under which calculation resources perform parallel calculation of a target program and includes a number of processes of the target program; based on the parallel calculation condition, extracting a number of processes that maximizes calculation performance in a case where the calculation resources perform eigenvalue calculation of matrix data, for each of a plurality of pieces of matrix data with different sizes; and setting a number of processes to be performed when the target program performs the eigenvalue calculation, based on a number of processes for each of a plurality of pieces of matrix data with different sizes extracted in the extracting and a matrix size of the target program.

### CROSS-REFERENCE TO RELATED APPLICATION

This application is based upon and claims the benefit of priority of the prior Japanese Patent Application No. 2022-47641, filed on Mar. 23, 2022, the entire contents of which are incorporated herein by reference.

### FIELD

The embodiment discussed herein is related to a computer-readable recording medium storing an information processing program, and the like.

### BACKGROUND

Expectations for a large-scale simulation using an exascale calculator such as a supercomputer have been increasing, and various techniques have to be used for the achievement. Matrix calculation is one of calculations used in a simulation, and eigenvalue calculation is a representative calculation of matrix calculation.

Japanese Laid-open Patent Publication No. 2005-135243 and Japanese Laid-open Patent Publication No. 2004-5528 are disclosed as related art.

### SUMMARY

According to an aspect of the embodiments, a non-transitory computer-readable recording medium stores an information processing program for causing a computer to execute a process including: receiving a setting of a parallel calculation condition that is a condition under which calculation resources perform parallel calculation of a target program and includes a number of processes of the target program; based on the parallel calculation condition, extracting a number of processes that maximizes calculation performance in a case where the calculation resources perform eigenvalue calculation of matrix data, for each of a plurality of pieces of matrix data with different sizes; and setting a number of processes to be performed when the target program performs the eigenvalue calculation, based on a number of processes for each of a plurality of pieces of matrix data with different sizes extracted in the extracting and a matrix size of the target program.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional block diagram illustrating a configuration of an information processing apparatus according to the present embodiment;

FIG. 2 is a diagram illustrating an example of a data structure of a parallel calculation characteristic table;

FIG. 3 is a flowchart illustrating a processing procedure of the extraction unit;

FIG. 4 is a flowchart illustrating a processing procedure of number-of-processes (NP) extraction processing;

FIG. 5 is a flowchart illustrating a processing procedure for executing an eigenvalue performance measurement PG;

FIG. 6 is a diagram illustrating an example of a relationship between matrix size (N) and number of processes (NP_DATA);

FIG. 7 is a flowchart illustrating a processing procedure for setting an eigenvalue parallel calculation condition;

FIG. 8 is a flowchart illustrating a processing procedure of the information processing apparatus according to the present embodiment;

FIG. 9 is a diagram illustrating a relationship between parallel number of eigenvalue calculation and calculation time; and

FIG. 10 is a diagram illustrating an example of a hardware configuration of a computer that implements functions similar to those of the information processing apparatus of the embodiment.

### DESCRIPTION OF EMBODIMENTS

Eigenvalue calculation of a symmetric dense matrix is one of basic matrix calculations that have to be performed in various simulations including quantization calculation.

For example, as an eigenvalue calculation library, there is scalable linear algebra package (ScaLAPACK) that supports distributed parallel calculation. Development of eigenvalue solvers for petaflop applications (ELPA), EigenExa, and the like is being advanced to achieve higher performance of eigenvalue calculation of a large-scale matrix. A large-scale matrix means a matrix with a large-scale dimension.

On the other hand, in a practical simulation, there are many problems of small-scale matrices, and a relationship between a parallel calculation condition and calculation performance is a characteristic derived from an eigenvalue calculation algorithm and the hardware architecture of a calculator.

Eigenvalue calculation of a symmetric dense matrix is normally performed through a calculation procedure of the following steps S1, S2, and S3. ScaLAPACK in which the calculation procedure of steps S1 to S3 is implemented for a distributed parallel environment is used in a wide range of simulations.

Tridiagonalization of a matrix (step S1).

Calculation of eigenvalues of the tridiagonal matrix (step S2).

Calculation of eigenvectors based on the eigenvalues (step S3).

Since the calculation performance of a large-scale matrix is limited by the operation performance of a hardware architecture, maximum calculation performance may be obtained by allocating the maximum available calculator resources to a parallel calculation condition.

On the other hand, the calculation performance of a small-scale matrix is a characteristic derived from an eigenvalue calculation algorithm and the hardware architecture of a calculator, and performance deterioration of the corresponding program may become significant due to performance instability of eigenvalue calculation.

For example, the bottleneck in the calculation procedure of steps S1 to S3 described above is tridiagonalization of a matrix. The main causes of the bottleneck are the sequential nature of calculation and the fact that about half of the calculation results in a matrix product with low execution performance.

For example, a byte per flop (BF) ratio of a matrix product is 16/N. N is a matrix size. The effective performance of a small-scale matrix depends on the matrix size and is limited by the memory bandwidth of a calculator. This means that as the value of BF ratio is smaller, the number of bytes used for one operation is smaller, and the amount of transfer between memories may be reduced.

BF ratio of a calculator tends to decrease in recent years, and the BF ratio of a standard calculator is 0.12. In an eigenvalue parallel calculation condition of related art, in order to avoid performance deterioration due to parallel calculation, the upper limit of the parallel number (number of processes) is limited by a matrix size N that satisfies formula (1) in units of parallel calculation. For example, when the BF ratio of a standard calculator is 0.12, the matrix size N that satisfies formula (1) is 134 or larger.

$$\begin{matrix}\text{BF ratio of matrix product} \left(16 / \text{N}\right) \leq \text{BF ratio of standard calculator} \\ \left(0.12\right)\end{matrix} \qquad \text{(1)}$$

For example, since the upper limit of the number of processes is limited in a small-scale matrix, the number of processes of the corresponding program may not be used to the maximum extent, and performance deterioration of the corresponding program is significant due to the hardware architecture of a calculator.

According to one aspect, an object of the present disclosure is to provide an information processing program and an information processing method capable of extracting an eigenvalue parallel calculation condition that maximizes the eigenvalue calculation performance within available calculator resources.

An embodiment of an information processing program and an information processing method disclosed herein will be described in detail with reference to the drawings. This embodiment does not limit this disclosure.

### 0034 Embodiment

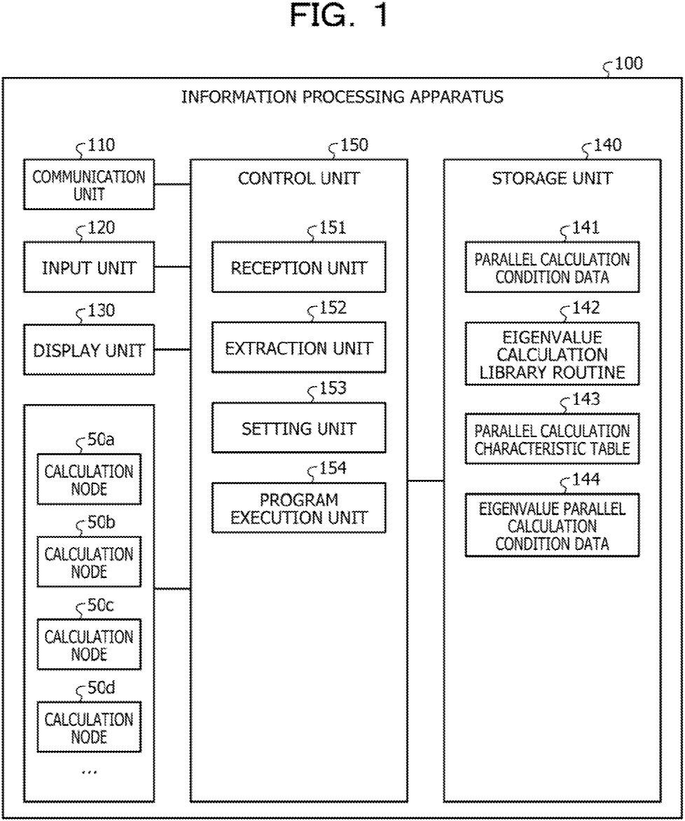

A configuration example of an information processing apparatus according to the present embodiment will be described. FIG. 1 is a functional block diagram illustrating a configuration of the information processing apparatus according to the present embodiment. As illustrated in FIG. 1, an information processing apparatus 100 includes a communication unit 110, an input unit 120, a display unit 130, a storage unit 140, and a control unit 150.

The information processing apparatus 100 includes a plurality of calculation nodes 50a, 50b, 50c, and 50d that execute allocated processes. Although the calculation nodes 50a to 50d are illustrated, the information processing apparatus 100 may include other calculation nodes. In the following description, the calculation nodes 50a to 50d and other calculation nodes are collectively referred to as calculation nodes 50. The calculation nodes 50 are coupled to each other by an external interface such as a local area network (LAN).

The communication unit 110 transmits and receives information to and from an external device or the like via a network. For example, the communication unit 110 is realized by a network interface card (NIC) or the like. The information processing apparatus 100 may transmit information such as a calculation result to an external device via the communication unit 110.

The input unit 120 is realized by using an input device such as a keyboard or a mouse, and inputs various types of information to the control unit 150 in response to an input operation by a user. For example, a user operates the input unit 120 and inputs parallel calculation condition data 141 and the like to be described later.

The display unit 130 is realized by a display device such as a liquid crystal display, or the like.

The storage unit 140 includes parallel calculation condition data 141, an eigenvalue calculation library routine 142, a parallel calculation characteristic table 143, and eigenvalue parallel calculation condition data 144. For example, the storage unit 140 is realized by a semiconductor memory element such as a flash memory or a storage device such as a hard disk or an optical disk.

A parallel calculation condition, under which a certain program is executed in available calculation resources, is set in the parallel calculation condition data 141. For example, the available calculation resources are the calculation nodes 50 or the like. The certain program is a simulation program for quantum science calculation or the like. In the following description, the certain program is referred to as “the program”.

The parallel calculation condition data 141 includes the number of threads per process included in the program, the number of processes per calculation node 50, the number of calculation nodes 50, and the number of processes. For example, the number of processes (NP_PG) is defined by formula (2).

$$\begin{matrix}\text{NP\_PG} \text{=} \text{number of processes per calculation node} \times \text{number of} \\ \text{calculation nodes}\end{matrix} \qquad \text{(2)}$$

The eigenvalue calculation library routine 142 is a program for performing measurement of eigenvalue calculation performance. The eigenvalue calculation library routine 142 is ScaLAPACK or the like.

The parallel calculation characteristic table 143 is a table that holds the number of processes (NP_DATA) that maximizes the eigenvalue calculation performance in the available calculation resources corresponding to a matrix size (N). The number of processes (NP_DATA) in the parallel calculation characteristic table 143 is calculated by the control unit 150.

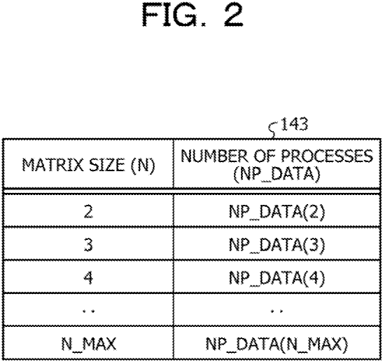

FIG. 2 is a diagram illustrating an example of a data structure of the parallel calculation characteristic table. As illustrated in FIG. 2, in the parallel calculation characteristic table 143, a matrix size (N) is associated with the number of processes (NP_DATA). For example, the number of processes that maximizes the eigenvalue calculation performance in the available calculation resources corresponding to the matrix size N = 2 is NP_DATA(2).

The number of processes (NP_DATA) corresponding to the matrix size of eigenvalue calculation of the program is set in the eigenvalue parallel calculation condition data 144.

The description returns to FIG. 1. The control unit 150 includes a reception unit 151, an extraction unit 152, a setting unit 153, and a program execution unit 154. The control unit 150 is realized by a central processing unit (CPU) or a microprocessor unit (MPU). For example, the control unit 150 may be realized by an integrated circuit such as an application-specific integrated circuit (ASIC) or a field-programmable gate array (FPGA).

The reception unit 151 receives input of the parallel calculation condition data 141 from the input unit 120. The reception unit 151 stores the parallel calculation condition data 141 in the storage unit 140. The reception unit 151 may receive the parallel calculation condition data 141 from an external device or the like via the communication unit 110.

The extraction unit 152 extracts the number of processes (NP_DATA) that maximizes the eigenvalue calculation performance in the available calculation resources corresponding to a matrix size (N). For example, the extraction unit 152 stores a matrix size and the extracted number of processes in the parallel calculation characteristic table 143. For example, the extraction unit 152 extracts the number of processes (NP_DATA) corresponding to the matrix size 2 to the maximum matrix size (N_MAX).

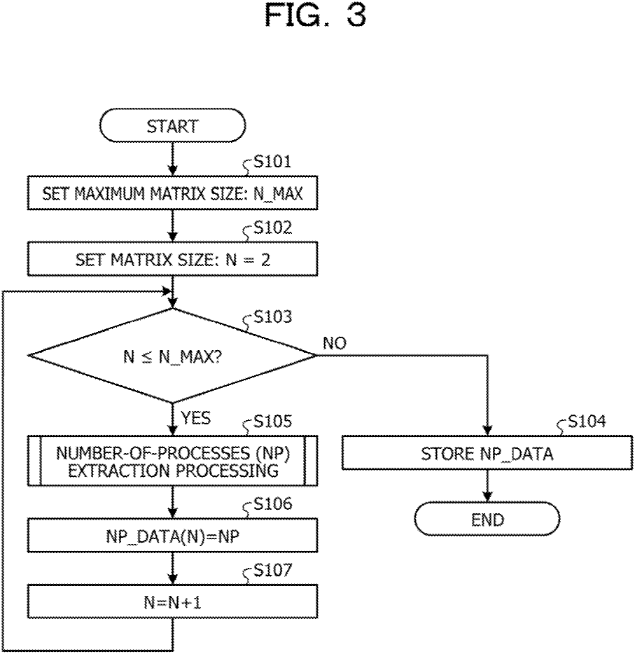

FIG. 3 is a flowchart illustrating a processing procedure of the extraction unit. As illustrated in FIG. 3, the extraction unit 152 of the information processing apparatus 100 sets maximum matrix size: N_MAX (step S101). The extraction unit 152 sets matrix size: N = 2 (step S102).

When a condition of N ≤ N_MAX is not satisfied (step S103, No), the extraction unit 152 stores NP_DATA in the parallel calculation characteristic table 143 (step S104).

On the other hand, when the condition of N ≤ N_MAX is satisfied (step S103, Yes), the extraction unit 152 executes number-of-processes (NP) extraction processing (step S105).

The extraction unit 152 sets NP = NP_DATA(N) (step S106). The extraction unit 152 sets N = N + 1 (step S107), and proceeds to step S103.

Next, the number-of-processes (NP) extraction processing illustrated in step S105 in FIG. 3 will be described. The extraction unit 152 extracts the number of processes (NP) with maximum calculation performance that maximizes the eigenvalue calculation performance (minimizes the calculation time of eigenvalue calculation) from among the numbers of processes (P) “P = 4 to the number of processes of the program (NP_PG)”.

When the eigenvalue calculation performance is measured, the extraction unit 152 generates symmetric dense matrix sample data, calls the eigenvalue calculation library routine 142, executes a performance measurement program for eigenvalue calculation, and measures the number of processes (NP) with maximum calculation performance. An arbitrary value is set as a matrix element of the symmetric dense matrix sample data. In the following description, the performance measurement program for eigenvalue calculation is referred to as the “eigenvalue performance measurement PG”.

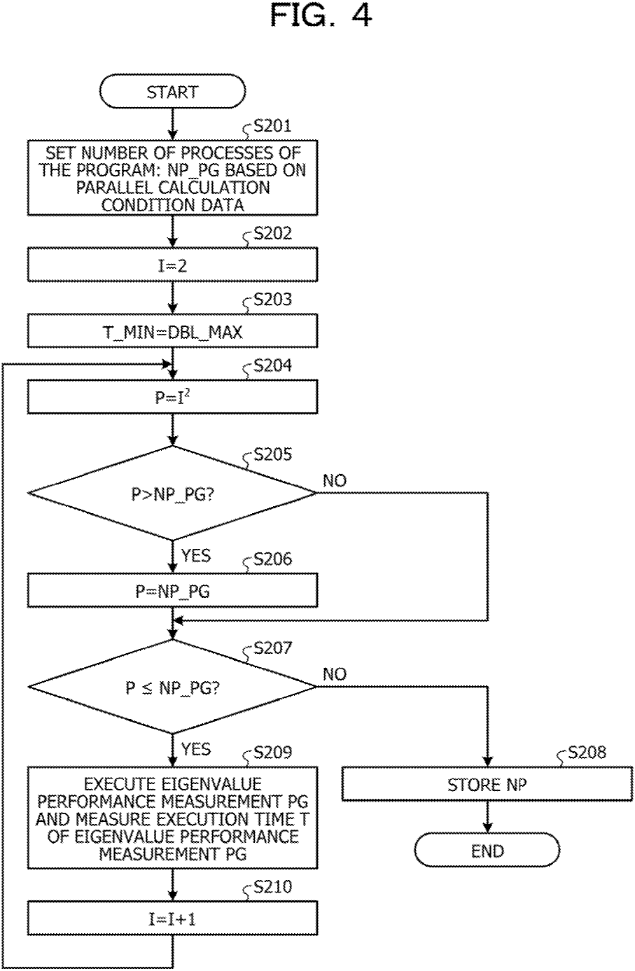

FIG. 4 is a flowchart illustrating a processing procedure of the number-of-processes (NP) extraction processing. As illustrated in FIG. 4, the extraction unit 152 of the information processing apparatus 100 sets the number of processes of the program: NP_PG based on the parallel calculation condition data 141 (step S201). The extraction unit 152 sets I = 2 (step S202). I is a variable for determining the number of processes. The extraction unit 152 sets T_MIN = DBL_MAX (step S203). A sufficiently large value is set in advance for DBL_MAX.

The extraction unit 152 sets P = I² (step S204). The extraction unit 152 determines whether a condition of P > NP_PG is satisfied (step S205). When the condition of P > NP_PG is not satisfied (step S205, No), the extraction unit 152 proceeds to step S207.

On the other hand, when the condition of P > NP_PG is satisfied (step S205, Yes), the extraction unit 152 sets P = NP_PG (step S206).

The extraction unit 152 determines whether a condition of P ≤ NP_PG is satisfied (step S207). When the condition of P ≤ NP_PG is not satisfied (step S207, No), the extraction unit 152 stores NP (step S208).

On the other hand, when the condition of P ≤ NP_PG is satisfied (step S207, Yes), the extraction unit 152 executes the eigenvalue performance measurement PG and measures execution time T of the eigenvalue performance measurement PG (step S209). The extraction unit 152 sets I = I + 1 (step S210), and proceeds to step S204.

Next, the processing of executing the eigenvalue performance measurement PG illustrated in step S209 in FIG. 4 will be described. The extraction unit 152 generates symmetric dense matrix sample data having the same matrix size as the matrix size (N). The extraction unit 152 calls the eigenvalue calculation library routine 142 and executes the performance measurement program for eigenvalue calculation on the symmetric dense matrix sample data, thereby extracting the number of processes (NP) with maximum calculation performance that maximizes the eigenvalue calculation performance.

When the number of processes of the program (NP_PG) and the number of processes of eigenvalue calculation are the same, the extraction unit 152 executes the following processing. For convenience, description will be given with the number of processes of the program (NP_PG) = M.

The extraction unit 152 divides the matrix data (symmetric dense matrix sample data) into M pieces. The extraction unit 152 causes M calculation nodes 50 to execute the M pieces of divided matrix data (one calculation node 50 executes one piece of data among the M pieces of matrix data). Each of the M calculation nodes 50 executes parallel calculation of the eigenvalue performance measurement PG and obtains a calculation result. The extraction unit 152 integrates the calculation results obtained by the M calculation nodes 50. The extraction unit 152 measures time T to be spent for each of the M calculation nodes 50 to execute the eigenvalue performance measurement PG and obtain a calculation result.

On the other hand, when the number of processes of the program (NP_PG) is different from the number of processes of eigenvalue calculation, the extraction unit 152 executes the following processing. For convenience, description will be given with the number of processes of the program (NP_PG) = M and the number of processes of eigenvalue calculation as L. M is larger than L.

The extraction unit 152 divides the matrix data (symmetric dense matrix sample data) into M pieces. The extraction unit 152 distributes the M pieces of divided matrix data to L calculation nodes 50 (distributes the matrix data by dividing the data into L pieces), and causes the calculation nodes to execute the matrix data. Each of the L calculation nodes 50 executes parallel calculation of the eigenvalue performance measurement PG, and distributes a calculation result to the M calculation nodes 50 including the calculation node itself. The extraction unit 152 integrates the calculation results obtained by the M calculation nodes 50. The extraction unit 152 measures time T to be spent for each of the M calculation nodes 50 to execute the eigenvalue performance measurement PG and obtain a calculation result.

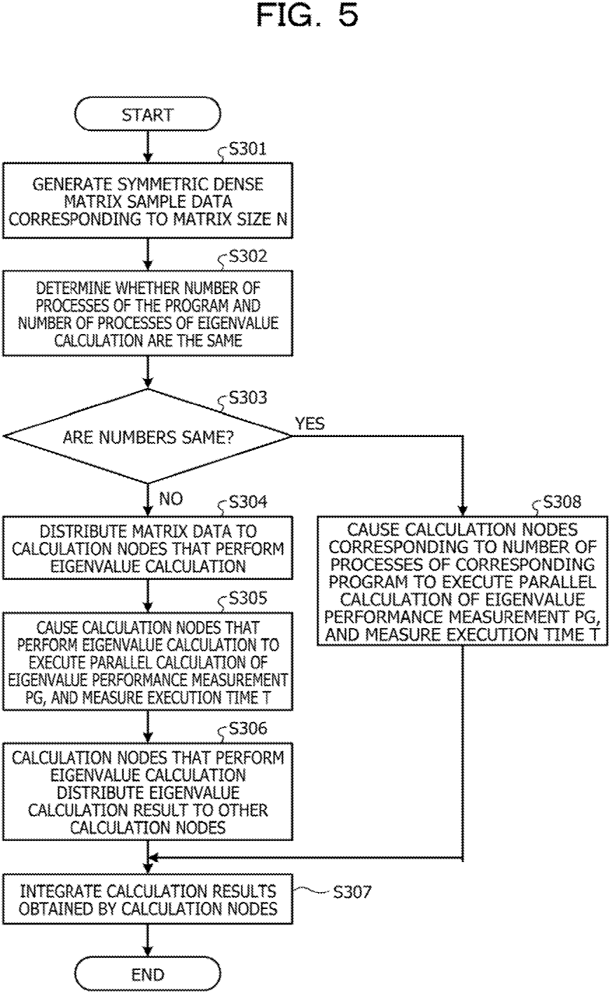

FIG. 5 is a flowchart illustrating a processing procedure for executing the eigenvalue performance measurement PG. As illustrated in FIG. 5, the extraction unit 152 of the information processing apparatus 100 generates symmetric dense matrix sample data corresponding to the matrix size N (step S301). The extraction unit 152 determines whether the number of processes of the program and the number of processes of eigenvalue calculation are the same (step S302).

When the number of processes of the program and the number of processes of eigenvalue calculation are not the same (step S303, No), the extraction unit 152 distributes the matrix data to the calculation nodes 50 that perform eigenvalue calculation (step S304).

The extraction unit 152 causes the calculation nodes 50 that perform eigenvalue calculation to execute parallel calculation of the eigenvalue performance measurement PG, and measures execution time T (step S305). The calculation nodes 50 that perform eigenvalue calculation distribute an eigenvalue calculation result to other calculation nodes 50 (step S306). The extraction unit 152 integrates the calculation results obtained by the calculation nodes 50 (step S307).

On the other hand, when the number of processes of the program and the number of processes of eigenvalue calculation are the same (step S303, Yes), the extraction unit 152 proceeds to step S308. The extraction unit 152 causes the calculation nodes corresponding to the number of processes of the corresponding program to execute parallel calculation of the eigenvalue performance measurement PG, and measures execution time T (step S308), and proceeds to step S307.

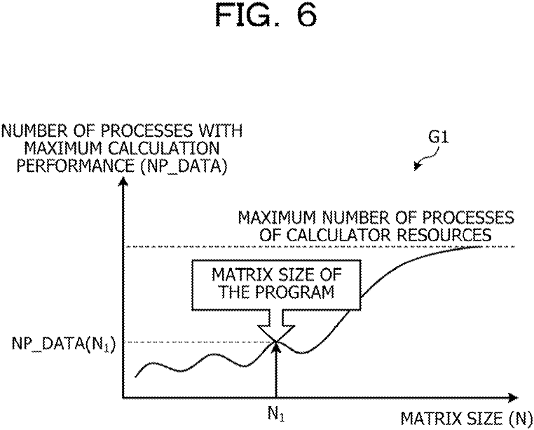

By the extraction unit 152 executing the above-described processing, data in which matrix size (N) and the number of processes (NP_DATA) are associated with each other is stored in the parallel calculation characteristic table 143. FIG. 6 is a diagram illustrating an example of a relationship between matrix size (N) and number of processes (NP_DATA). In graph G1 of FIG. 6, the vertical axis is an axis corresponding to the number of processes with maximum calculation performance (NP_DATA). The horizontal axis is an axis corresponding to matrix size (N). Matrix size (N) is 2 to the maximum matrix size (N_MAX). For example, the number of processes with maximum calculation performance corresponding to the matrix size (N₁) is NP_DATA(N₁).

The setting unit 153 extracts the number of processes (NP_DATA) corresponding to the matrix size of eigenvalue calculation of the program based on the parallel calculation characteristic table 143. When the matrix size of eigenvalue calculation is equal to or larger than the maximum matrix size (N_MAX), the setting unit 153 performs processing with the matrix size as N_MAX. The setting unit 153 sets the extracted number of processes (NP_DATA) in the eigenvalue parallel calculation condition data 144. The setting unit 153 sets the number of processes (NP_DATA) of the eigenvalue parallel calculation condition data 144 as the number of processes of eigenvalue calculation in the program.

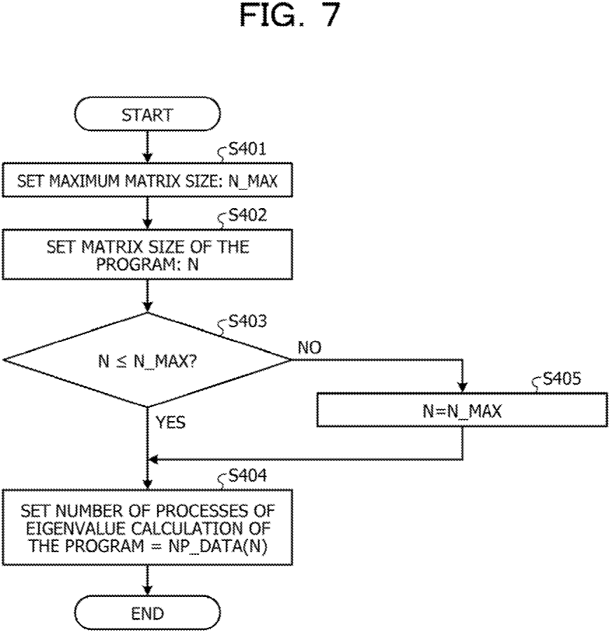

FIG. 7 is a flowchart illustrating a processing procedure for setting an eigenvalue parallel calculation condition. As illustrated in FIG. 7, the setting unit 153 of the information processing apparatus 100 sets maximum matrix size: N_MAX (step S401). The setting unit 153 sets matrix size of the program: N (step S402).

When the condition of N ≤ N_MAX is satisfied (step S403, Yes), the setting unit 153 sets the number of processes of eigenvalue calculation of the program = NP_DATA(N) (step S404).

On the other hand, when the condition of N ≤ N_MAX is not satisfied (step S403, No), the setting unit 153 sets N = N_MAX (step S405), and proceeds to step S404.

The description returns to FIG. 1. The program execution unit 154 executes the corresponding program under the conditions of the parallel calculation condition data 141 and the eigenvalue parallel calculation condition data 144. The program execution unit 154 may output an execution result to the display unit 130 to be displayed, or may transmit the execution result to an external device.

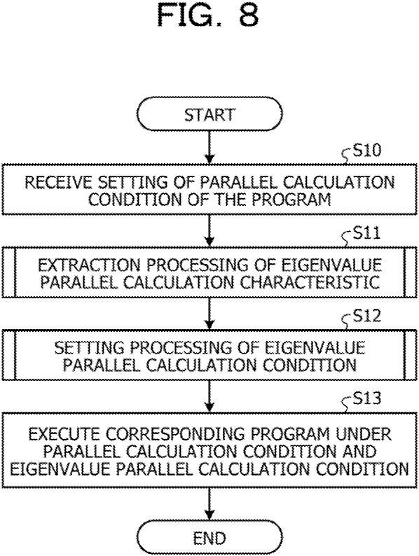

Next, an example of a processing procedure of the information processing apparatus 100 according to the present embodiment will be described. FIG. 8 is a flowchart illustrating a processing procedure of the information processing apparatus according to the present embodiment. As illustrated in FIG. 8, the reception unit 151 of the information processing apparatus 100 receives input of the parallel calculation condition data 141 of the program (step S10).

The extraction unit 152 of the information processing apparatus 100 executes extraction processing of an eigenvalue parallel calculation characteristic (step S11). For example, the processing of step S11 corresponds to the processing described with reference to FIGS. 2 to 4, which is executed by the extraction unit 152. An eigenvalue parallel calculation characteristic stored in a calculator resource that is the same as the execution environment of the program may be reused.

The setting unit 153 of the information processing apparatus 100 executes setting processing of an eigenvalue parallel calculation condition (step S12). For example, the processing of step S12 corresponds to the processing of FIG. 7 executed by the setting unit 153.

The program execution unit 154 of the information processing apparatus 100 executes the corresponding program under the parallel calculation condition and the eigenvalue parallel calculation condition (step S13).

Next, an effect of the information processing apparatus 100 according to the present embodiment will be described. The information processing apparatus 100 according to the present embodiment extracts, for each of a plurality of pieces of matrix data with different sizes, the number of processes that maximizes calculation performance in a case where the calculation nodes 50 perform eigenvalue calculation on the matrix data, based on the input parallel calculation condition data 141. The information processing apparatus 100 sets the number of processes to be performed when the corresponding program performs eigenvalue calculation, based on the extracted number of processes for each of the plurality of pieces of matrix data with different sizes and the matrix size of the corresponding program. Accordingly, an eigenvalue parallel calculation condition that maximizes the eigenvalue calculation performance within available calculator resources may be extracted. The performance of eigenvalue calculation may be optimized.

For example, the inventor conducted an experiment for the performance of eigenvalue calculation in molecular dynamics using “CP2K” as the program. CP2K is an open-source first principles calculation library that supports the pseudopotential method and the all-electron calculation method. As the basis, a Gaussian basis, a plane wave basis, and a mixed basis thereof may be used, and large-scale parallel calculation and linear scaling are good. Various first principles calculation methods such as the density functional method and the Hartree-Fock method are supported.

A64FX version of FUJITSU SSL2 library was used as the eigenvalue calculation library. The size of symmetric dense matrix is 432, and the parallel calculation conditions of software are 6 threads/process, 256 processes, and 32 calculation nodes.

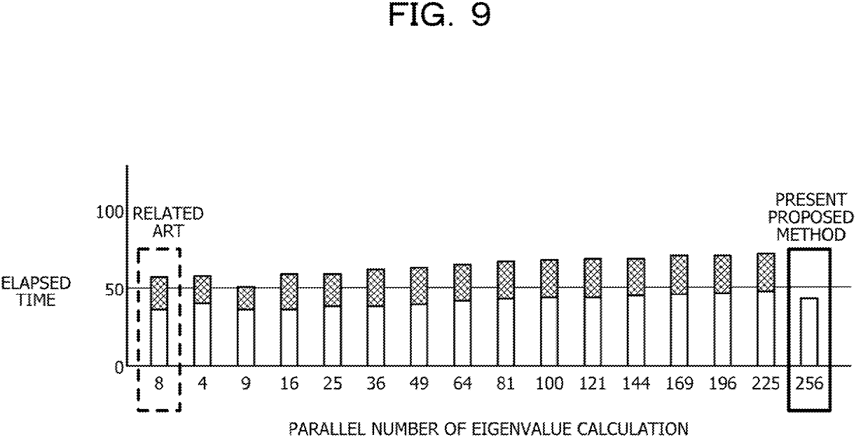

In related art, a preset number of processes of eigenvalue calculation (parallel number) is “8”. On the other hand, by the information processing apparatus 100 performing the above-described processing, the number of processes of eigenvalue calculation “256” is extracted and set. FIG. 9 is a diagram illustrating a relationship between parallel number of eigenvalue calculation and calculation time. In FIG. 9, the horizontal axis corresponds to parallel number of eigenvalue calculation, and the vertical axis corresponds to elapsed time. In the bar graph of FIG. 9, a non-shaded portion indicates elapsed time of eigenvalue calculation, and a shaded portion indicates elapsed time that has to be taken for distribution of matrix data and distribution of a result.

For example, when parallel number is “8” as in related art, elapsed time is “57.138”. On the other hand, when parallel number is “256” extracted by the information processing apparatus 100 of the present embodiment, elapsed time is “43.066”. The high-speed magnification of elapsed time of the information processing apparatus 100 is “1.33” as compared with the elapsed time of related art, and the performance of eigenvalue calculation is optimized.

The information processing apparatus 100 calculates the number of processes (NP_PG) based on formula (2). Accordingly, the number of processes that maximizes calculation performance in a case where eigenvalue calculation of matrix data is performed may be extracted for each of a plurality of pieces of matrix data with different sizes, in the range of the number of processes that may be executed by calculation resources.

When the number of processes of the program is different from the number of processes of eigenvalue calculation, the information processing apparatus 100 distributes symmetric dense matrix sample data to calculation nodes that are included in the calculation nodes 50 and perform eigenvalue calculation, and causes the calculation nodes to execute a performance measurement program for eigenvalue calculation. The information processing apparatus 100 executes processing of distributing, to other calculation nodes, the results of eigenvalue calculation obtained by the calculation nodes that perform eigenvalue calculation. Accordingly, even when the number of processes of the program is different from the number of processes of eigenvalue calculation, an eigenvalue parallel calculation condition that maximizes the eigenvalue calculation performance may be extracted.

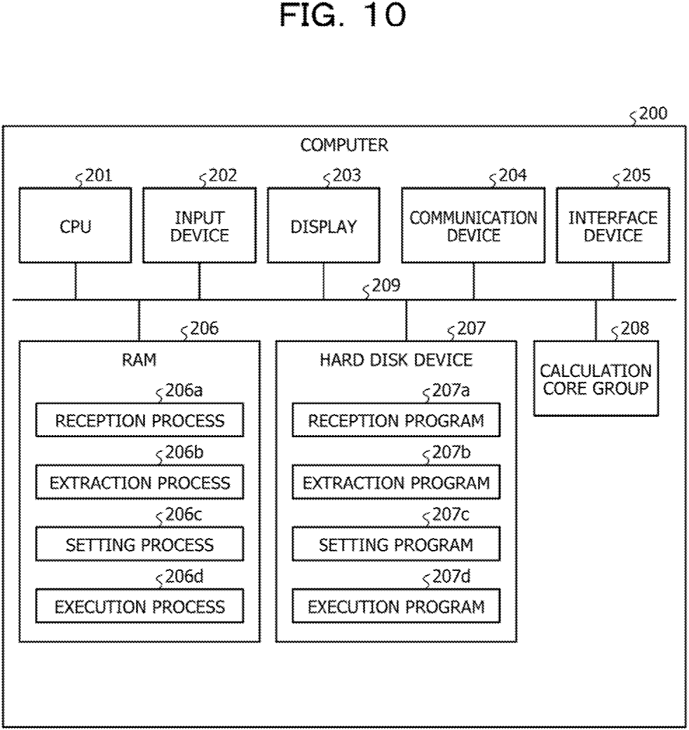

Next, description will be given for an example of a hardware configuration of a computer that implements functions similar to those of the information processing apparatus 100 described in the above embodiment. FIG. 10 is a diagram illustrating an example of a hardware configuration of a computer that implements functions similar to those of the information processing apparatus of the embodiment.

As illustrated in FIG. 10, a computer 200 includes a CPU 201 that executes various kinds of arithmetic processing, an input device 202 that receives input of data from a user, and a display 203. The computer 200 includes a communication device 204 that exchanges data with an external device or the like via a wired or wireless network, and an interface device 205. The computer 200 includes a random-access memory (RAM) 206 that temporarily stores various kinds of information, and a hard disk device 207. The computer 200 includes a calculation core group 208. The calculation core group 208 includes a plurality of calculation cores, and the calculation cores are coupled to each other by an external interface or the like. The devices 201 to 207 and the calculation core group 208 are coupled to a bus 209.

The hard disk device 207 includes a reception program 207a, an extraction program 207b, a setting program 207c, and an execution program 207d. The CPU 201 reads each of the programs 207a to 207d and loads the programs to the RAM 206.

The reception program 207a functions as a reception process 206a. The extraction program 207b functions as an extraction process 206b. The setting program 207c functions as a setting process 206c. The execution program 207d functions as an execution process 206d.

The processing of the reception process 206a corresponds to the processing of the reception unit 151. The processing of the extraction process 206b corresponds to the processing of the extraction unit 152. The processing of the setting process 206c corresponds to the processing of the setting unit 153. The processing of the execution process 206d corresponds to the processing of the program execution unit 154.

Each of the programs 207a to 207d does not have to be stored in the hard disk device 207 in advance. For example, each program is stored in a “portable physical medium”, such as a flexible disk (FD), a compact disc read-only memory (CD-ROM), a Digital Versatile Disc (DVD), a magneto-optical disk, or an integrated circuit (IC) card, that is inserted into the computer 200. The computer 200 may read and execute each of the programs 207a to 207d.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an information processing program for causing a computer to execute a process comprising:
receiving a setting of a parallel calculation condition that is a condition under which calculation resources perform parallel calculation of a target program and includes a number of processes of the target program;
based on the parallel calculation condition, extracting a number of processes that maximizes calculation performance in a case where the calculation resources perform eigenvalue calculation of matrix data, for each of a plurality of pieces of matrix data with different sizes; and
setting a number of processes to be performed when the target program performs the eigenvalue calculation, based on a number of processes for each of a plurality of pieces of matrix data with different sizes extracted in the extracting and a matrix size of the target program.

2. The non-transitory computer-readable recording medium according to claim 1, wherein the receiving further executes a process of receiving, as the parallel calculation condition, a number of processes per calculation node included in the calculation resources and a number of calculation nodes included in the calculation resources, and specifying, as a number of processes of the target program, a value obtained by multiplying the number of processes per calculation node included in the calculation resources by the number of calculation nodes.

3. The non-transitory computer-readable recording medium according to claim 1, wherein the extracting generates a plurality of pieces of symmetric dense matrix sample data with different sizes, causes the calculation resources to execute a performance measurement program for eigenvalue calculation for each piece of symmetric dense matrix sample data, measures execution time of parallel calculation of each piece of symmetric dense matrix sample data by the calculation resources for each of different numbers of processes, and extracts a number of processes that minimizes the execution time.

4. The non-transitory computer-readable recording medium according to claim 3, wherein, when a number of processes of the target program is different from a number of processes of eigenvalue calculation, the extracting executes a process of distributing symmetric dense matrix sample data to calculation nodes that are included in the calculation resources and perform eigenvalue calculation and causing the calculation nodes to execute a performance measurement program for eigenvalue calculation, and distributing results of eigenvalue calculation obtained by the calculation nodes that perform eigenvalue calculation to other calculation nodes.

5. An information processing method comprising:
receiving a setting of a parallel calculation condition that is a condition under which calculation resources perform parallel calculation of a target program and includes a number of processes of the target program;
based on the parallel calculation condition, extracting a number of processes that maximizes calculation performance in a case where the calculation resources perform eigenvalue calculation of matrix data, for each of a plurality of pieces of matrix data with different sizes; and
setting a number of processes to be performed when the target program performs the eigenvalue calculation, based on a number of processes for each of a plurality of pieces of matrix data with different sizes extracted in the extracting and a matrix size of the target program.

6. The information processing method according to claim 5, wherein the receiving further executes a process of receiving, as the parallel calculation condition, a number of processes per calculation node included in the calculation resources and a number of calculation nodes included in the calculation resources, and specifying, as a number of processes of the target program, a value obtained by multiplying the number of processes per calculation node included in the calculation resources by the number of calculation nodes.

7. The information processing method according to claim 5, wherein the extracting generates a plurality of pieces of symmetric dense matrix sample data with different sizes, causes the calculation resources to execute a performance measurement program for eigenvalue calculation for each piece of symmetric dense matrix sample data, measures execution time of parallel calculation of each piece of symmetric dense matrix sample data by the calculation resources for each of different numbers of processes, and extracts a number of processes that minimizes the execution time.

8. The information processing method according to claim 7, wherein, when a number of processes of the target program is different from a number of processes of eigenvalue calculation, the extracting executes a process of distributing symmetric dense matrix sample data to calculation nodes that are included in the calculation resources and perform eigenvalue calculation and causing the calculation nodes to execute a performance measurement program for eigenvalue calculation, and distributing results of eigenvalue calculation obtained by the calculation nodes that perform eigenvalue calculation to other calculation nodes.
